(19) United States
(12) Patent Application Publication
(10) Pub. No.: US 2024/0352882 A1
(43) Pub. Date: Oct. 24, 2024

(54) APPARATUS FOR PROTECTING A CATALYTIC CONVERTER

(71) Applicant: RB Distribution, Inc., Colmar, PA (US)

(72) Inventors: Ricardo Llorente RUIZ, Perkasie, PA (US); Daniel E. THEOBOLD, Center Valley, PA (US)

(73) Assignee: RB Distribution, Inc., Colmar, PA (US)

(21) Appl. No.: 18/302,314

(22) Filed: Apr. 18, 2023

(51) Int. Cl. F01N 3/28; F16L 3/12

(52) U.S. Cl. CPC F01N 3/2839; F16L 3/1211; F01N 2260/22

(57) ABSTRACT

An apparatus for protecting a component of an exhaust system using a hinged clamp. The clamp has grouped links that are joined by hinge pins that fit within apertures in the links and the grouped links are movable relative to each other about the hinges. A closer that draws the ends of selected links together is also disclosed.

### BACKGROUND

Modern exhaust systems often include a catalytic converter as part of the required system. These catalytic converters typically include precious metal and rare earth elements that make them expensive. This inclusion of precious metal and rare earth elements have spawned a new form of theft that is based on cutting the catalytic converter from the vehicle's exhaust system. There have been a number of attempts to address this issue with theft deterrents. These prior attempts have provided devises that: are difficult to install; may trap heat that can create a fire hazard; or, trap road debris.

### SUMMARY

The present apparatus includes a layered and hinged clamp that is easily installed; has a reduced profile; and, has a limited impact on air flow around the catalytic converter.

### BRIEF DESCRIPTION OF THE DRAWINGS

FIG. 1 illustrates the clamp positioned about both a larger diameter and a smaller diameter exhaust pipe;

FIG. 2 illustrates an exploded view of the clamp and closer in FIG. 1;

FIG. 3 illustrates the clamp of FIG. 1 closed about a larger diameter pipe;

FIG. 4 illustrates the clamp of FIG. 1 with an opened closer;

FIG. 5 is a plan view of the illustration in FIG. 3;

FIG. 6 illustrates another embodiment of the clamp and closer;

FIG. 7 is a plan view of the clamp and closer in FIG. 5;

FIG. 8 is a side view of the clamp and closer in FIG. 5;

FIG. 9 illustrates the second embodiment of FIG. 5 positioned about both a larger diameter and a smaller diameter exhaust pipe;

FIG. 10 illustrates the clamp of FIG. 1 closed clamp on a smaller diameter exhaust pipe;

FIG. 11 illustrates a link suitable for assembling a hinged clamp as illustrated in FIG. 1;

FIG. 12 illustrates a link suitable for assembling a hinged clamp as illustrated in FIG. 6;

FIG. 13 illustrated another link suitable for assembling a hinged clamp as illustrated in FIG. 6; and,

FIG. 14 illustrates a protective apparatus installed on a catalytic converter.

### DETAILED DESCRIPTION

Illustrative embodiments of a catalytic convertor theft determent will be described with reference to the above described drawings.

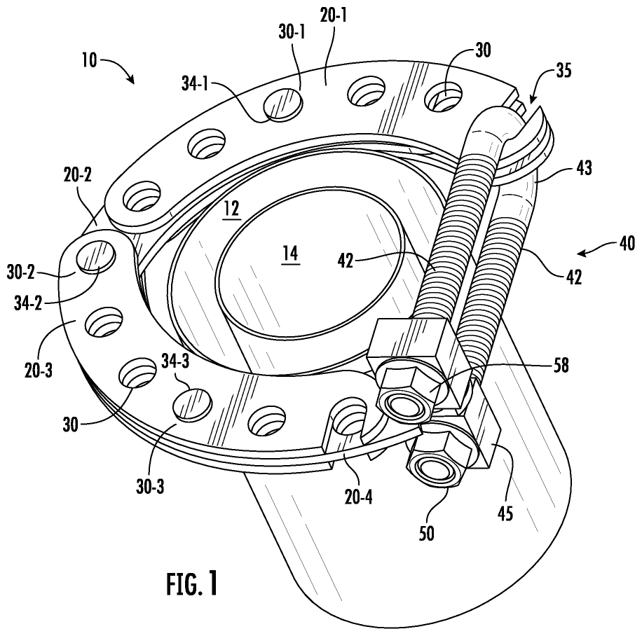

With reference now to FIG. 1, the apparatus includes a hinged clamp 10 constructed of multiple links that are layered together. In the illustrated clamp 10, the individual links 20-1, 20-2, 20-3, and 20-4 that a common structure with a plurality of apertures 30 and an end 35 that configured to receive a closer 40. The clamp 10 is illustrated around a large diameter exhaust pipe 12 and a smaller diameter exhaust pipe 14.

The links 20-1, 20-2, 20-3, and 20-4 are joined in a hinged clamp 10 by individual hinge pins 34 that pass through aligned apertures 30 in the layered links. The links 20-1 and 20-2 are joined by the hinge pin 34-1. The links 20-3 and 20-4 are joined by hinge pin 34-3. The link 20-2 and 20-3 are joined by the hinge pin 34-2, which forms the central hinge for the clamp 10.

This hinge pin structure permits movement of the links within a group of links and movement between the groups of links. This provides flexibility and enables use of the same clamp 10 on larger diameter pipes, like 12, and smaller diameter pipes, like 14. Placing the hinge pins 34-1 and 34-3 at least one aperture in from the free ends provides a more even and distributed clamping pressure.

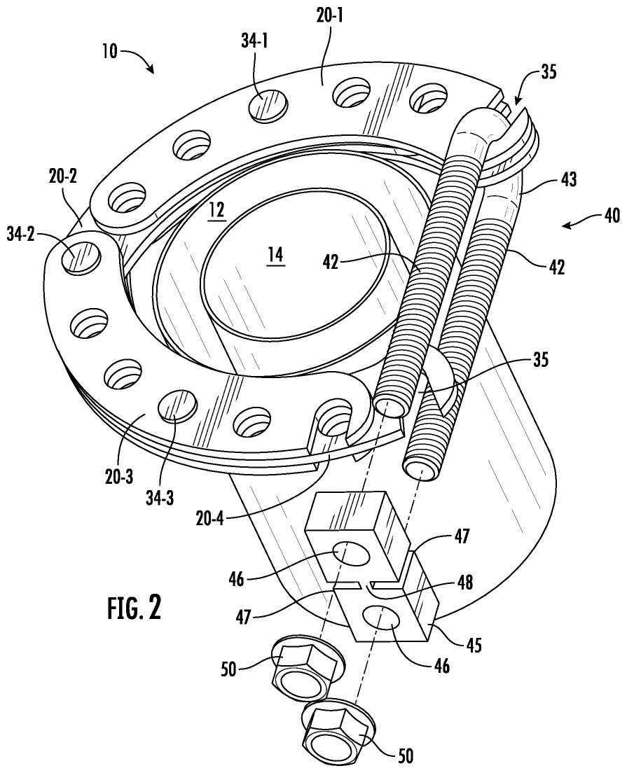

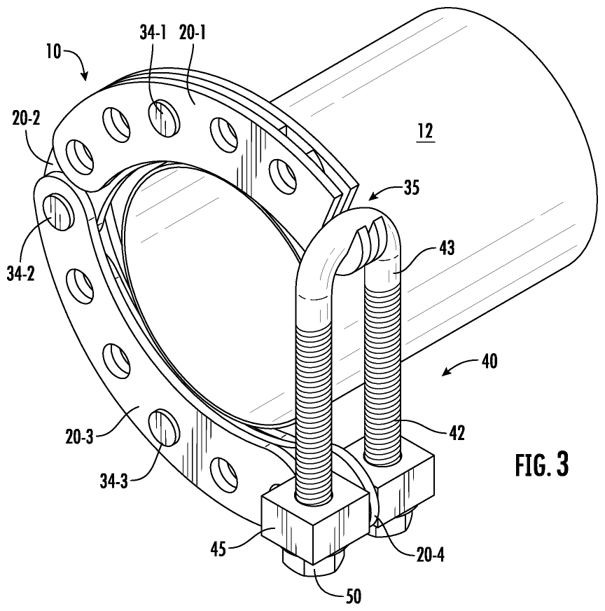

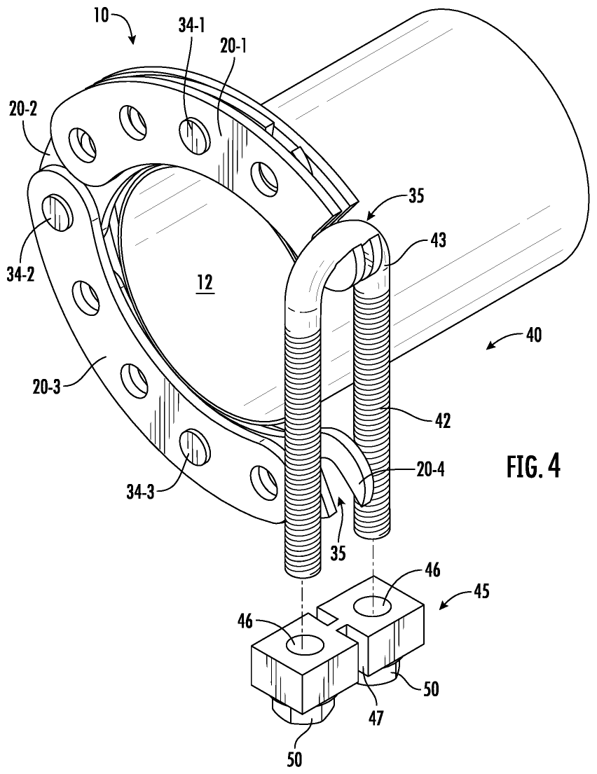

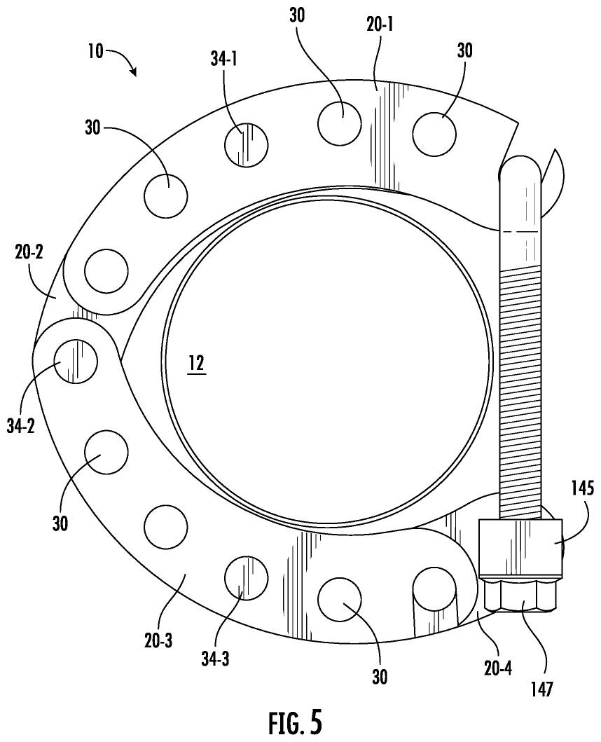

With reference to FIGS. 1 and 2, the closer 40 is generally “U” shaped to form and arch 43 with threaded shafts 42 that depend from the arch 43. The arch 43 is dimensioned to fit in the end 35 of the links 20-1. Which is hook shaped and engages the links 20-1. The securing collar 45 has apertures 46 that are spaced apart and dimensioned for the treaded shafts 42 to pass through. The two recesses 47 in securing collar 45 are between the holes 46 and create an interior divider 47. In use, the securing collar 45 moves up the shafts 42 and the interior divider 47 of the securing collar 45 is received in the end 35 of the link 20-4. Tightening element or nuts 50 on shafts 42 causes the fee ends of the clamp 10 to be drawn together and tighten around the exhaust pipe. FIGS. 3, 4 and 5 illustrate closing the clamp 10 on a larger diameter pipe.

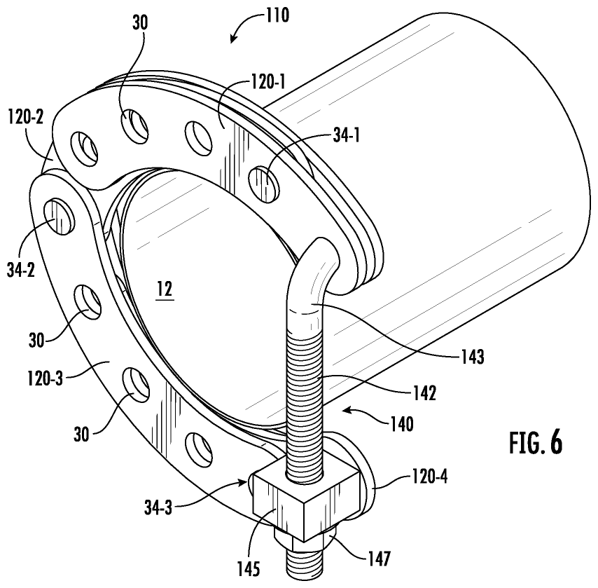

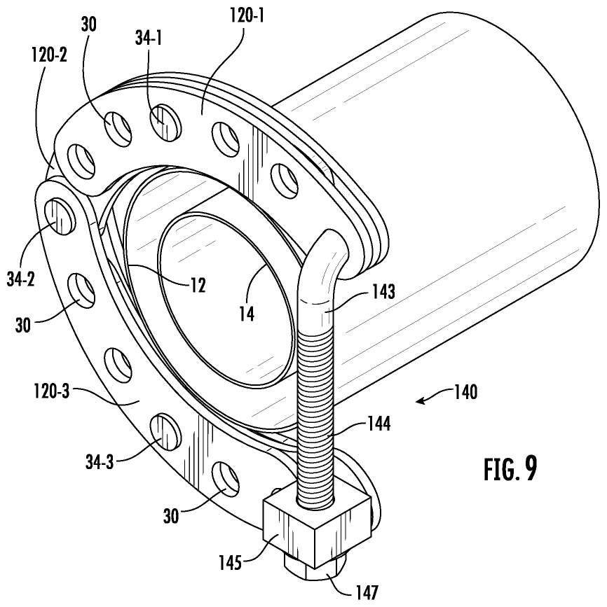

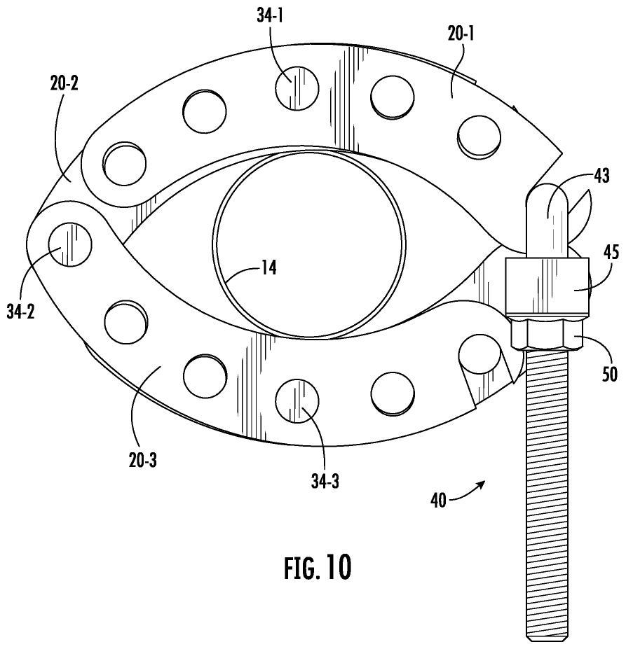

FIGS. 6 through 9 illustrate another embodiment of a clamp 110 with another embodiment of a closure element 140 on a larger diameter pipe 12. In this embodiment of the clamp 110, the clamp is constructed of multiple links as described in the prior embodiment; however, the illustrated embodiment has five apertures 130 in each of the links 120. The individual links 120-1, 120-2, 120-3, and 120-4 have a common structure with a plurality of apertures 130 and an end 135, which is a closed end in this embodiment, that is configured to receive the closer 140.

With reference to FIG. 6, the closer element 140 has a threaded shaft 144 passes through at least one link and is turned to be parallel with the clamp 110 by the arch 143 so the enlarger head 142 abuts against the link. A joining collar 145 with an open bore is secured to the end link 120-4 by and the enlarged head 146 abuts the link. When the ends of the clamp 110 are brought together, the closer element 140 passes through the joining collar 145 and fastening element or nut 147 mates with the threads 144 closes the clamp.

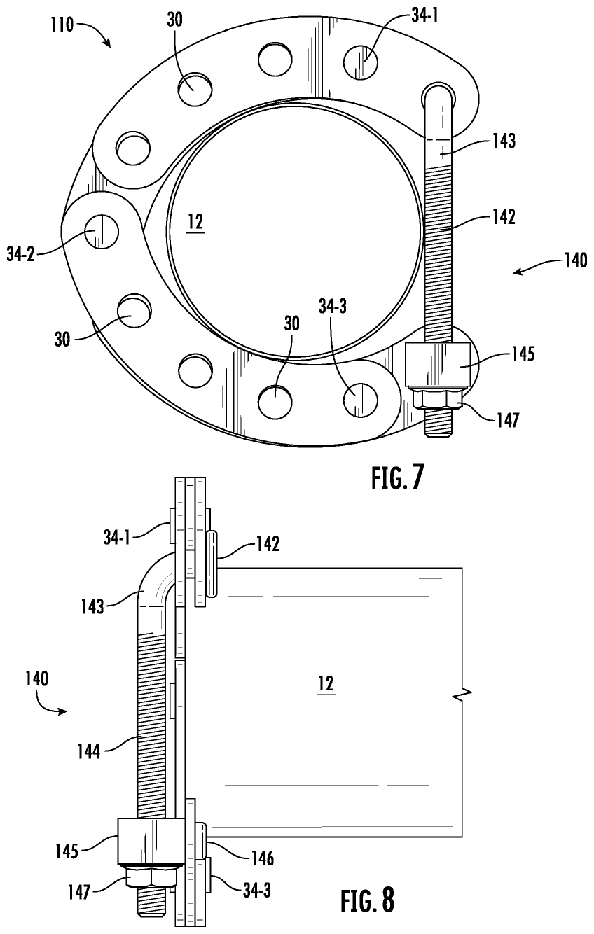

FIGS. 7 and 8 illustrate the clamp 110 about a larger diameter pipe 12. FIG. 8 illustrates the clamp 110 closed about a larger diameter pipe 12 and a smaller diameter pipe 14. In the embodiment illustrated in FIGS. 6-9, each link 110 has six apertures 130, which are all closed links.

FIG. 11 illustrates a link 20 with five apertures 30 and an open aperture that forms the end 35.

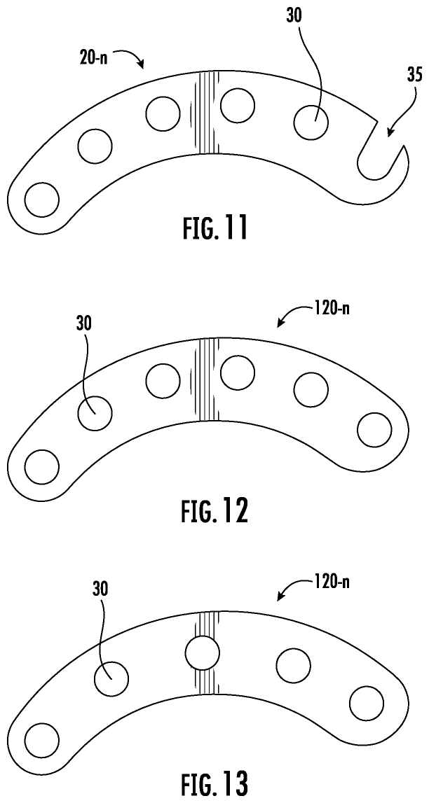

FIG. 12 illustrates a link 120 with six closed apertures.

FIG. 13 illustrates a link 120 with five closed apertures.

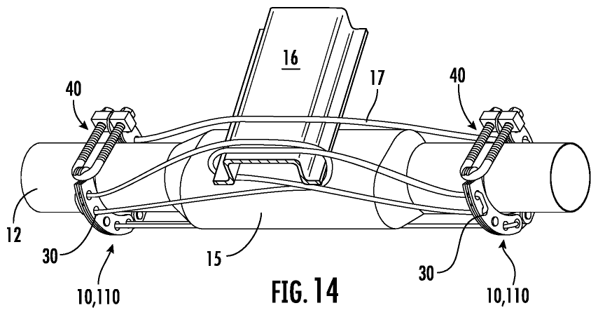

The use either clamp 10 or clamp 110 with a catalytic convertor will be explained with reference to FIG. 14. FIG. 14 illustrates a catalytic converter 15 with larger diameter pipes 12 at either end. The two hinged clamps 10, 110 are secured on the pipe 12 on either side of the catalytic converter 15. After the clamps are secured, a cable 17 is strung between the two clamps through the apertures 30 and around a frame component 16. The cable 17 passes through the apertures 30 and around the convertor to form a cage like structure around the converter and the ends of the cables are secured by a cable clamp or other fastening means. As a result, cutting the exhaust pipes 12 on either side of the catalytic converter 15 will not free the converter from the frame component 16 and a potential thief will be delayed or stopped from removing the converter. Additionally, the converter may be saved for reattachment to the system.

The sections of the clamps 10 and 110 may be made of stainless steel or another cut resistant metal. The cables are also made of a cut cur resistant material and may by wire rope such as that used for light duty cranes or overhead lifting clamps. In like manner, the closures 40 and 140 are formed from a cut resistant material.

The orientation of the hinged clamps will depend on the available space where the catalytic converter is located and the availability of an anchor position on the vehicle.

The tightening elements or nuts 45 and 147 are shown as hex nuts for purposes of illustration; however, other nuts, such McMaster-Carr temper-resistant, tri-grove nuts, may be used to enhance theft resistance by increasing the difficulty of trying to remove the clamps to free a convertor.

What is claimed is:

1. A clamp for protecting a component of an exhaust system, the clamp comprising:
a plurality of links, where each link has a body portion with a plurality of apertures configured to receive a hinge pin and selected link among the plurality of links has free ends configured to receive a clamp closer;
a plurality of hinge pins that fit within selected apertures among the plurality of apertures and connect the plurality of links together for relative movement between the plurality of links; and,
a closer that draws the free ends of selected links together.

2. The clamp of claim 1, wherein each of multiple sections of the clamp is made of cut resistant stainless steel.

3. The clamp of claim 1, wherein the closure element is made of cut resistant stainless steel.

4. The clamp of claim 1, wherein the plurality of links are joined together in groups by the hinge pins.

5. The clamp of claim 4, wherein the clamp is made of stainless steel.

6. The clamp of claim 1, wherein the closer is comprised of a threaded portion, a securing collar, and a threaded closing element that complements the threaded portion.

7. The clamp of claim 6, wherein the closer is arched and has two dependent threaded portions.

8. The clamp of claim 7, wherein the securing collar has two portions joined by a divider and the two portions of the securing collar are spaced to receive the two threaded portion of the closer.

9. The clamp of claim 1, wherein the closer has a threaded portion fixed to one free end and a securing collar fixed to another free end and positioned to receive the threaded portion therein.

10. A kit for assembling a barrier around a catalytic converter in an exhaust system, the kit comprising:
at least two clamps that are dimensioned to be positioned on either side of a catalytic converter, each clamp has:
a plurality of links joined together by a plurality of hinge pins;
selected links among the plurality of links in each clamp have a plurality of apertures that are dimensioned for passage of a cable through them;
selected links among the plurality of links in each clamp have at least one free end configured to receive a closure element;
a tightening element that mates with the closure element and draws the clamp ends together; and,
a cable that passes between the at least two clamps through selected apertures in the at least two clamps to form a barrier around a catalytic converter and join the barrier to a frame member.

11. The kit of claim 10, wherein the closure element has a threaded portion and the tightening element is a threaded nut.

12. The kit of claim 11, wherein the tightening element is a tamper-resistant threaded nut.

13. The kit of claim 11, wherein the tamper-resistant is a tri-grove nut.

14. A clamp for an exhaust system, the clamp comprising:
a plurality of links, each link has a body portion with a plurality of apertures and an end configured to receive a clamp closer;
a plurality of hinge pins that connect the plurality of links together in groups that are movable relative each other; and,
a closer that draws the ends of selected links together.

15. A clamp comprising:
a plurality of links, each link has a body portion with at least three of apertures and a free end configured to receive a closer;
at least three hinge pins that fit within at least one of the at least three apertures in each link and connect the plurality of links together in groups that are movable relative each other; and,
a closer that fits within at least two free ends and draws the free end together.

16. A clamping assembly comprising:
a plurality of links having a body portion with at least three of apertures and a free end that receives a closer;
at least three hinge pins that connect the plurality of links together in groups that are movable relative each other; and,
a closer that is received in at least two free ends and draws the free end together.

17. The clamping assembly of claim 16, wherein two of the three hinge pins are located in apertures that are at least one aperture removed from free ends.
